(19) United States
(12) Patent Application Publication
(10) Pub. No.: US 2019/0351570 A1
(43) Pub. Date: Nov. 21, 2019

(54) Knife and Sheath with Retention System

(71) Applicant: John Siffermann, Western Springs, IL (US)

(72) Inventor: John Siffermann, Western Springs, IL (US)

(21) Appl. No.: 16/296,622

(22) Filed: Mar. 8, 2019

Related U.S. Application Data
(60) Provisional application No. 62/671,766, filed on May 15, 2018.

(51) Int. Cl. B26B 29/02; B26B 3/06

(52) U.S. Cl. CPC B26B 29/025; B26B 3/06

(57) ABSTRACT

A knife and sheath system includes a knife with a protrusion on its blade and a sheath having a blade guard with a pocket for the knife blade and a protrusion that extends in to its pocket and cooperates with the knife's protrusion. Additionally, a resilient action is positioned on the blade guard across from the protrusion and attaches to the blade guard at one end. When removing or inserting the knife, the action temporarily displaces, returning to its original shape once the knife is fully seated in the sheath or entirely removed. When fully seated in the sheath, the action locks the knife in place by applying force on the knife in the direction of the sheath protrusion. The sheath optionally also includes sheath supports on opposing sides so that a user can attach the sheath to his gear on either his left or right side.

### CROSS-REFERENCE TO RELATED APPLICATIONS

This application claims the benefit of co-pending provisional U.S. Application 62/671,766 filed May 15, 2018.

### FIELD OF THE INVENTION

The present invention relates to a novel and useful knife sheath with a retention system that cooperates with a knife useful in law enforcement and other fields.

### BACKGROUND OF THE INVENTION

Law enforcement officers and security professionals often wear a belt or vest that accommodates a variety of equipment. The vest or belt can be constructed of a durable material such as nylon or leather and is designed so that the person wearing it can safely stow equipment and keep his or her hands free to interact. For example, a police duty belt is designed to fit around an officer's waist and may hold a firearm and ammunition, handcuffs, a flashlight, a radio, and a baton. Similarly, a police vest is designed to be worn on an officer's torso and generally accommodates the same equipment as the police belt. Some officers prefer or need to wear a vest rather than a belt either improve range of motion and decrease back stress or because they need additional protection as can be provided by a bullet resistant vest.

Each equipment item supported by the duty belt or vest has a dedicated receptacle. The receptacle generally secures to the belt and is oriented such that the item can easily be removed and replaced by the officer when the officer is wearing the belt or vest. For items, such as firearms, security features are included to prevent the officer from being disarmed by another person. For example, many firearm holsters include a retention system that allows the officer to unlock the firearm and quickly remove it but that prevents anyone who is not wearing the belt or vest from easily disabling the lock. Popular holster retention systems for firearms include a spring-loaded hood, a trigger guard, and tension screws.

Like firearms, knives are popular for an officer or security professional to carry but dangerous if others can easily remove it from the officer's duty belt or vest. Typical duty belt receptacles for knives are sheaths that secure behind another accessory, such as a handcuff pouch. Unfortunately, however, sheaths are commonly secured in their sheath simply by friction and many do not include safety retention systems. Absent a retention mechanism, a knife could easily be removed by someone other than the officer wearing the duty belt, which could turn into a deadly force scenario. If another person removed the knife from officer's duty belt, the unauthorized person become a threat to the officer and others, which in turn may provide the officer with cause to use deadly force against the perpetrator. It would be desirably to provide a sheath that prevents or discourages unauthorized removal of a knife from an officer's sheath by another.

Some recent attempts to secure a knife in its sheath for use with duty belts include a sliding lock system. The sliding lock system combines a sliding lock that is operated by the user's thumb; in order to remove the knife, the user pushes the lock with his thumb in a direction opposite of the knife while removing the knife. Unfortunately, such a lock is cumbersome for the officer and may hinder rapid removal of the knife. Accordingly, a knife sheath that prevents unauthorized removal of a knife would be a notable advance. Moreover, a knife retention system that also promotes a quick and natural release for the knife's intended user would also be a notable advance. Additionally, a knife sheath than can be worn on a user's right or left side would also be a notable advance.

### SUMMARY OF THE INVENTION

In accordance with the present invention a novel and useful knife and sheath with a retention system is herein provided. The knife includes a handle and blade with first and second cutting edges. Along the first edge, which is preferably a cutting edge, and near where the handle and blade meet, a knife protrusion extends from the blade edge. The knife protrusion cooperates with a complimentary sheath protrusion on the protective sheath. The sheath preferably includes at least one sheath support that allows the sheath to be mounted on a duty belt, tactical vest, or other gear. Attached to the support is a retention system with a blade guard, an optional spacer, and optional blade covers. The spacer can be sandwiched between the blade guard and the sheath support to provide some space that preferably takes into account the thickness of the handle when the knife is seated in the sheath. The blade covers can be inserted in the blade guard to cover the non-cutting surfaces of the knife. The blade guard can be constructed of one more sections and includes an edge guard perimeter section and a handle rest section. The edge guard perimeter section surrounds the edges of the knife blade and its point. The handle rest section connects the opposite ends of the edge guard perimeter section and forms a surface on which the handle can rest. The handle rest section also includes a pocket through which the blade can be inserted. The blade guard and retention system includes a sheath protrusion located in the handle rest section of the blade guard that compliments and cooperates with the knife protrusion on the knife blade and an action. The action is located opposite of the sheath protrusion and along the edge guard perimeter section. The action is temporarily displaced when the knife blade is being inserted or removed, and it returns to its original shape once the knife is seated in the sheath or entirely removed. When the knife is seated in the sheath, the action applies force on the knife in the direction of the sheath protrusion, which causes the knife to be secured in the sheath.

### BRIEF DESCRIPTION OF THE SEVERAL VIEWS OF THE DRAWING

FIG. 1 is a top view of a knife according to the present invention seated in a sheath according to a first embodiment of the present invention.

FIG. 2A is a top view of a preferred embodiment of a knife according to the present invention.

FIG. 2B is a top view of an alternative embodiment of a knife according to the present invention.

FIG. 3 is a top view of a first embodiment of a sheath according to the present invention.

FIG. 4 is a first side view of the sheath of FIG. 3.

FIG. 5 is a second side view of the sheath of FIG. 3.

FIG. 6 is a third side view of the sheath of FIG. 3.

FIG. 7 is a top view of the sheath support according to the first embodiment of the present invention.

FIG. 8 is a top view of the first blade guard and blade cover according to the first embodiment of the present invention.

FIG. 9 is a top view of the second blade guard and blade cover according to the first embodiment of the present invention.

FIG. 10 is an illustration of several embodiments of a blade protrusion cooperating with a sheath protrusion according to the present invention

FIG. 11A is an illustration of first embodiment of the action according to the present invention.

FIG. 11B is an illustration of several alternate embodiments of the action according to the present invention.

FIG. 11C is an illustration of an embodiment of the action as it is secured in the blade guard according to the present invention.

FIG. 11D is an illustration of an alternate embodiment of the action as it is secured in the blade guard according to the present invention.

FIG. 12A is an illustration of the knife as it is inserted and removed from the first embodiment of the sheath.

FIG. 12B is an illustration of knife seated in the first embodiment of the sheath.

FIG. 13 is a top view of the first blade guard according to a second embodiment of the present invention.

FIG. 14 is a top view of the second blade guard according to a second embodiment of the present invention.

FIG. 15 is a perspective view of the second blade guard according to a second embodiment of the present invention.

FIG. 16 is a perspective view of the first blade guard according to a second embodiment of the present invention.

FIG. 17A is a side view of the first blade cover according to the second embodiment of the present invention.

FIG. 17B is a top view of the first blade cover according to the second embodiment of the present invention.

FIG. 18A is a side view of the second blade cover according to the second embodiment of the present invention.

FIG. 18B is a top view of the second blade cover according to the second embodiment of the present invention.

FIG. 18C is a side view of the second blade cover according to the second embodiment of the present invention.

FIG. 19 is a first side view of the first and second blade guards and first and second blade covers as assembled according to the second embodiment of the present invention.

FIG. 20 is a second side view of the first and second blade guards and first and second blade covers as assembled according to the second embodiment of the present invention.

FIG. 21 is a third side view of the first and second blade guards and first and second blade covers as assembled according to the second embodiment of the present invention.

FIG. 22 is a perspective view of a belt attachment for use with the second embodiment of the present invention.

FIG. 23A is a side view of an embodiment of the action useful with the second embodiment of the present invention.

FIG. 23B is a perspective view of an embodiment of the action useful with the second embodiment of the present invention.

FIG. 24 is partial cutaway of the embodiment of the present invention as shown in FIG. 20 and cut along the line-24-.

For a better understanding of the invention reference is made to the following detailed description of the preferred embodiments of the invention which should be taken in conjunction with the above described drawings.

### DETAILED DESCRIPTION OF THE INVENTION

Various aspects of the present invention will evolve from the following detailed description of the preferred embodiments thereof which should be referenced to the prior described drawings.

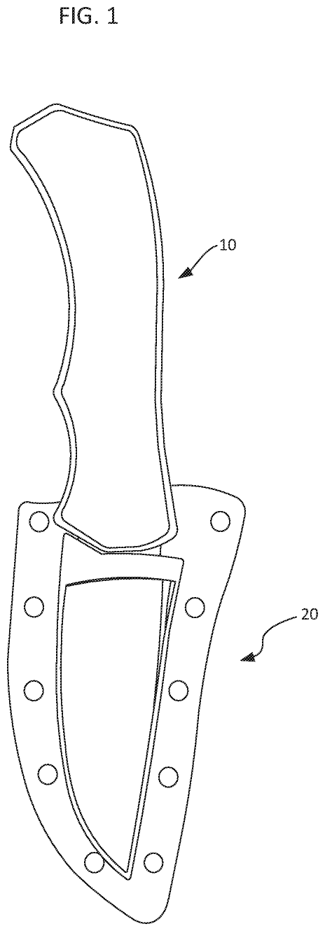

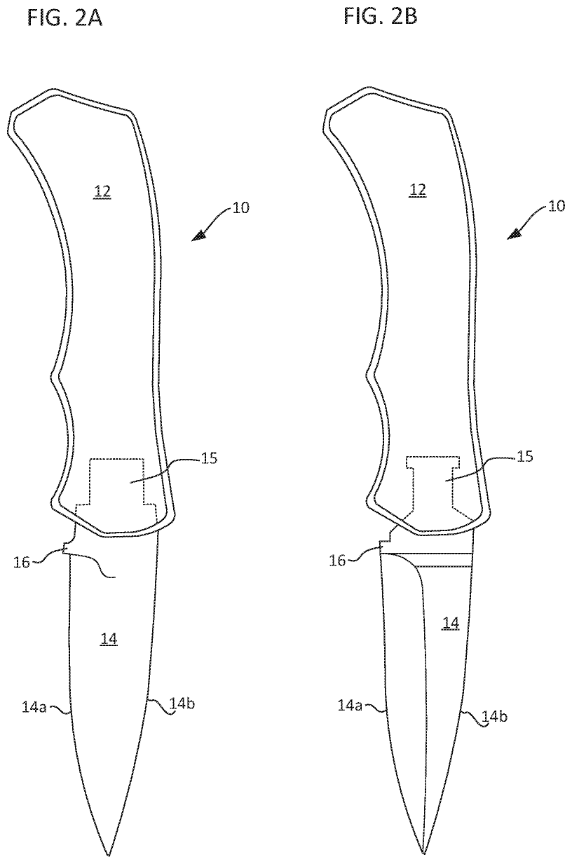

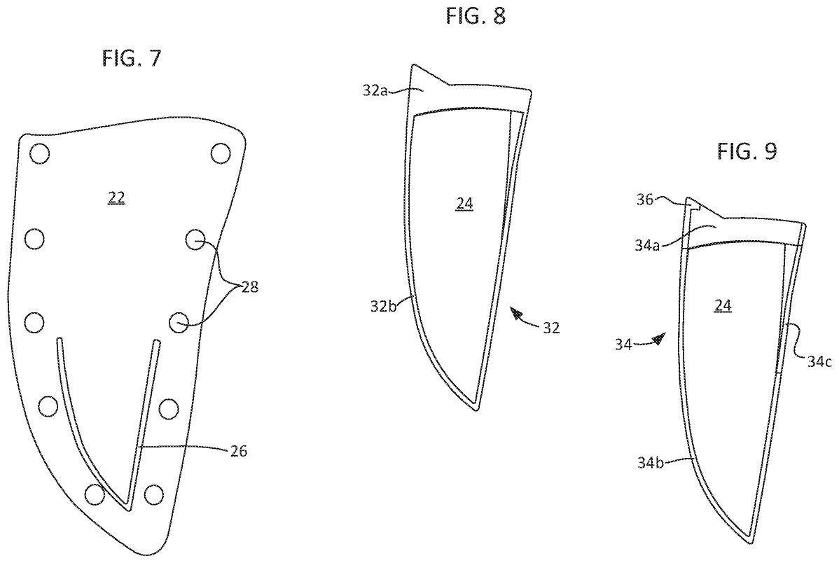

An embodiment of a knife 10 and cooperating sheath 20 is illustrated in FIGS. 1-12B. As shown in FIGS. 1-2B, the preferred knife is a standard fixed blade knife having a handle 12 and blade 14. Any type of knife that includes a handle and blade can be modified and used with the cooperating sheath 20 of the present invention provided the knife 10 can be secured in a fixed position. For example, a folding knife or retractable knife may be used, but the blade would need to be locked in the open position for it to cooperate with the sheath 20 of the present invention.

The handle of knife 10 can be any type of handle and comprised of any suitable handle material, as is known to those skilled in the art of making weapons. Similarly, handle 12 may include any features such as notches, curves, or grips commonly found on ordinary or tactical knives. Handle 12 may be formed from a single piece of material or it may be constructed from multiple sections fixedly attached together. Preferably, handle 12 comprises first and second sections that secure together such that they sandwich between them an extension 15 of blade 14 as shown in FIG. 2. The sections could be attached with adhesive, fasteners, or any other manner of securing items together securely as will be known to those.

Blade 14 of knife 10 includes the exposed blade portion (not labelled) and preferably the extension 15 that attaches to, or is secured between sections of, handle 12 as shown in FIGS. 2A and 2B. Blade 14 can be any type of material commonly used for knives as is known to those skilled in the art. For example, blade 14 may be carbon steel, stainless steel, tool steel, alloy steel, ceramics, and titanium. Blade 14 also can be any shape including, for example, clipped, deep pointed, spear pointed, dagger shaped, drop pointed, or sheep's foot shaped, and preferably blade 14 has a first edge 14a and a second edge 14b. More preferably, first edge 14a is a cutting edge. Cutting edge 14a may be any type of cutting edge such as serrated, fine, chiseled, beveled, convex, or V-shaped. While it is anticipated that the blade will have a cutting edge, the present invention also works for blades with dull edges or otherwise without cutting edges.

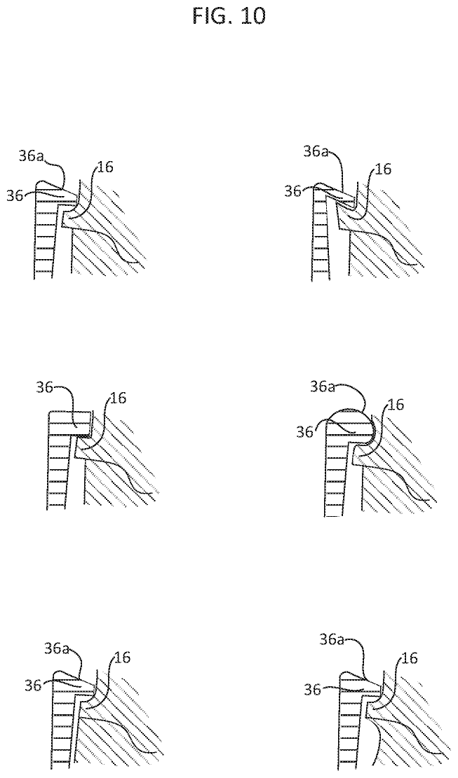

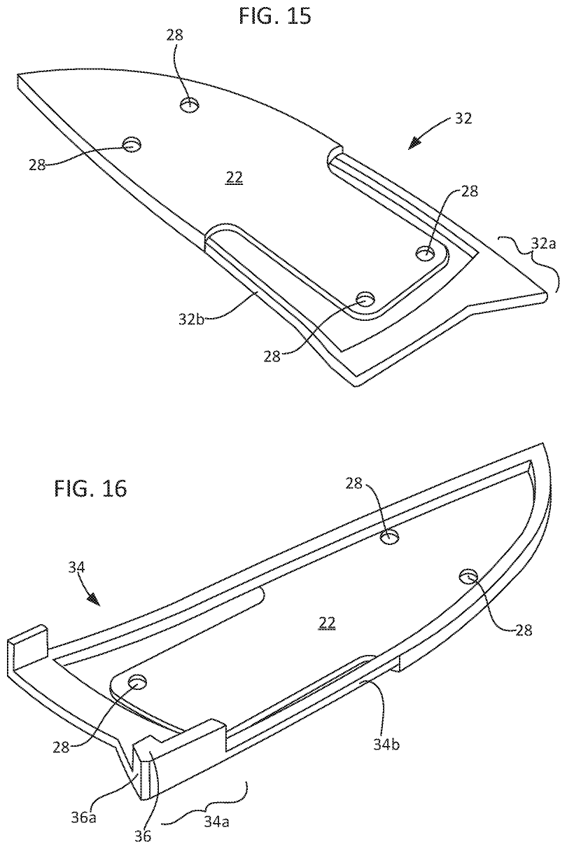

Knife 10, as shown in FIGS. 2A and 2B, further comprises a protrusion 16 along the cutting edge 14a of the blade and near where the blade 14 attaches to the handle 12. Protrusion 16 can be any shape and any type of projection, protrusion, ridge, bulge, bump, tooth, knob or the like as long as it extends generally away from the center of the knife and outward from a portion of the edge of the blade and is fixedly attached to the blade. FIGS. 2A and 2B show two embodiments of protrusion 16, and FIG. 10A illustrates several additional examples of different shapes of protrusions useful for the present invention. Preferably knife protrusion 16 is comprised of the same material as blade 14 and is integral with blade 14. The shape and size of protrusion 16 preferably cooperates with the retention system 30 and sheath protrusion 36 of the cooperating sheath 20 as described below and shown in FIGS. 3-21 and 24.

A first embodiment of sheath 20, as shown in FIGS. 1-12B, includes a sheath support 22, one or more blade covers 24, a spacer 26, and a retention system 30. Retention system 30 comprises a first blade guard 32, second blade guard 34, sheath protrusion 36, and action 38. When assembled, the sheath and retention system components form a first knife pocket 90 that accepts the blade 14 of knife 12. Preferably, the sheath and retention system components are shaped such that they substantially compliment or correspond to the shape of blade 14.

Sheath support 22 can be used to attach the sheath 20 to a duty belt, tactical vest, or other wearable or non-wearable item useful for holding knives. It may include clips, snaps, hook and loop closures, openings for screws, buttons, or other fasteners, or other features useful for attaching the sheath to a belt, vest, or other item. A shown in FIGS. 1 and 3, sheath support includes a plurality of openings 28 for fasteners. Sheath support may be made of a flexible material such as leather or a rigid material such as plastic. Preferably sheath support 22 is made from the same material as the sheath, such as acrylonitrile butadiene styrene (ABS), polylactic acid (PLA), or a composite, but any material is suitable as long as it can support the weight of knife 10. Sheath support 22 can be integrally formed with first or second blade guards, or it can be a separate component.

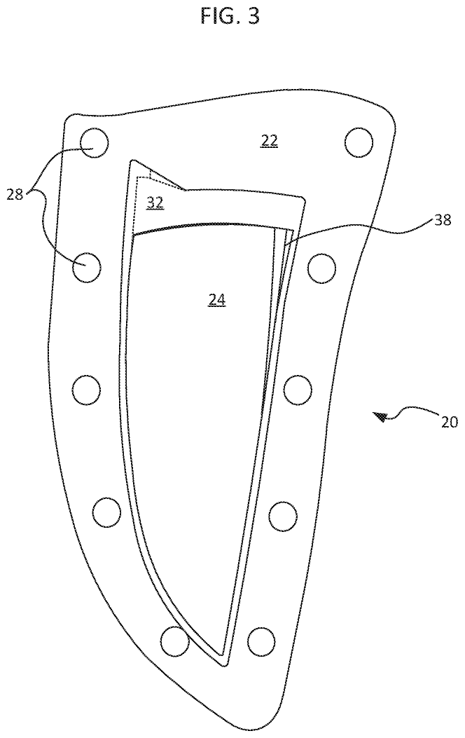

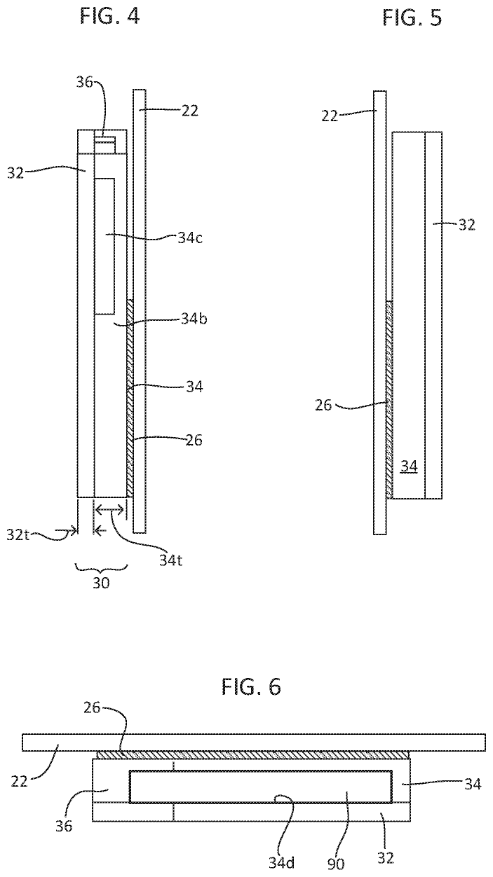

Attached to sheath support is an optional spacer 26 as shown in FIGS. 4-6 and the retention system 30. Spacer 26 may be any shape, but preferably conforms to the shape of first or second blade guards 32, 34 or retention system 30. The thickness of spacer 26 is preferably sufficient to account for the difference in thickness between the handle 12 and blade 14 of knife 10. Spacer 26 may be made of the same material as sheath support 22 or another material as long as it is sufficiently strong another to support the weight of knife 10. Spacer 26 preferably is fixedly attached to sheath support 22 with fasteners or adhesive or is integral with sheath support 22.

Retention system 30 includes first and second blade guards 32, 34 that substantially surrounds the edges of blade 14 that do not abut handle 12. The blade guard may be formed from one single piece of material such as where blade guards 32, 34 are one component or comprised of multiple sections for ease of manufacturing such as where blade guards 32, 34 are two sections that can be fastened or adhered together. The blade guard is preferably made from a strong material or combination of materials such as plastic or leather that is capable of supporting the weight of knife 10. As shown in the Figures, the blade guard has a first blade guard 32 and second blade guard 34. First blade guard 32 is substantially uniform in thickness 32t and includes a handle rest section 32a and a perimeter edge guard section 32b. Second blade guard 34 is substantially uniform in thickness 34t with handle rest section 34a and a perimeter edge guard section 34b. Second perimeter edge guard section 34b also defines an action opening 34c along the perimeter edge guard section 34b that is sized to accommodate the action 38, and second handle rest section 34 defines a blade opening 34d through the handle rest section 34a that is sized to accommodate blade 14 and generally forms the access point to knife pocket 90. First and second handle rest sections 34a and 32b are sized and shaped to cooperate with the edge of handle 12 when blade 14 is placed in sheath 20. First and second perimeter edge guard sections 34b and 32b are sized and shaped preferably to cooperate with and partially conform to the shape of blade 14.

Second handle rest section 34a of second blade guard 34 also defines sheath protrusion 36. Sheath protrusion 36 can be integral with second handle rest section 34a or it can be fixedly attached to it. Sheath protrusion 36 can be any shape or any type of protrusion and preferably is sized and formed to compliment and cooperate with knife protrusion 16 on knife first edge 14a. FIG. 10 illustrates several shapes and sizes of sheath protrusion 36 and how the sheath protrusion 36 compliments and cooperates with knife protrusion 16. While several combinations of protrusions 36, 16 are shown in FIG. 10, many other cooperating protrusion shapes and sizes can be used as will be understood by someone skilled in the art.

When first and second blade guards 32 and 34 are combined, the first and second perimeter edge guard sections 32b and 34b form a protective barrier around the edges of blade 14. They may also extend over the flat surfaces of blade 14 if desired or separate blade covers 24 may be inserted in the first and second blade guards 32 and 34 as shown in FIGS. 1, 8, and 9. Blade covers 24 may be made of the same material as blade guards 32 and 34 or something different. Blade covers 24 may be attached to blade guards 32 and 34 with fasteners, adhesives, or other means. Optionally, blade covers 24 may be held in place by the fit and design of guard sections 32 and 34.

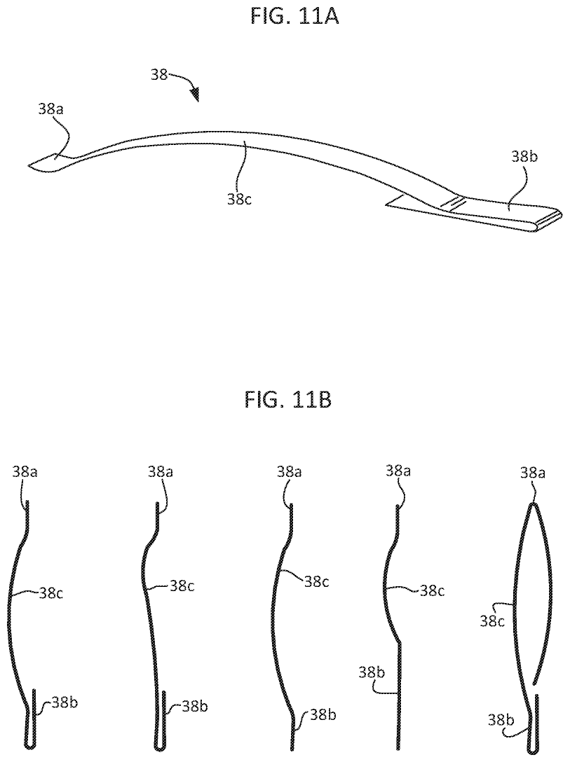

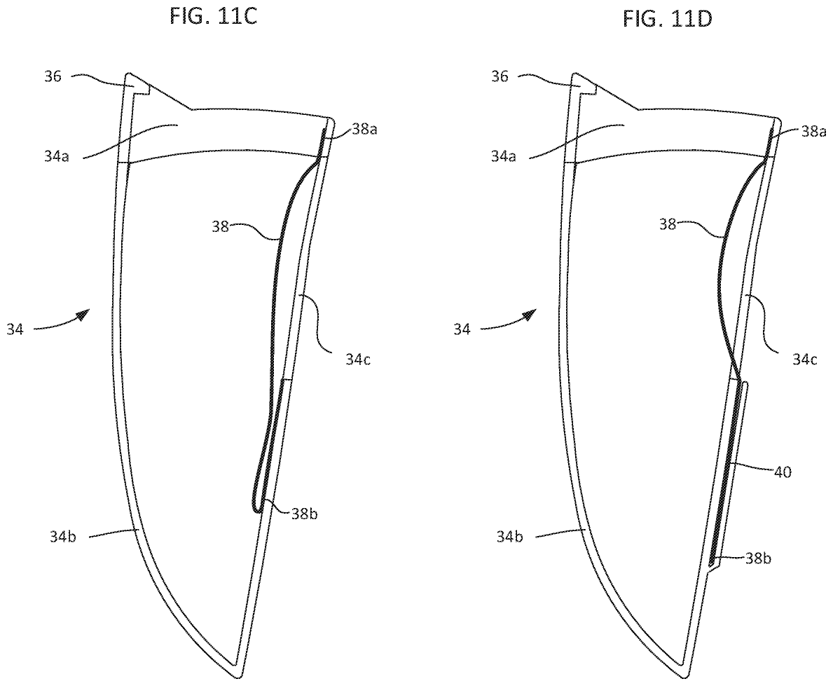

Attached along the second perimeter edge guard section 34b is action 38. Action 38 is positioned opposed the sheath protrusion 36 so that it is near or cooperates with second knife edge 14b when the knife blade 14 is seated in sheath 20. FIG. 11A illustrates action 38, and FIGS. 11C-D illustrate how the action may attach to the edge guard section 34b. Action 38 preferably has a first end 38a, a second end 38b, and a center 38c that extends from the first end 38a to the second end 38b, as shown in FIGS. 11A-B. Preferably, action 38 comprises a resilient and elastic material such as steel, and first end 38a, middle or center section 38c, and second end 38b are integrally formed. Preferably center section 38c is curved or shaped such that when no force is applied, action 38 is biased to lock the knife protrusion 16 of knife blade 14 with sheath protrusion 36 and when pressure is applied to the curve center section elastically displaces until the pressure is removed, the knife protrusion is released, and the knife can be inserted or removed. FIG. 11B illustrates several examples of how action 38 can be shaped, and additional shapes are appropriate as long as they perform in the same manner. As shown in FIGS. 11C-D, second end 38b is anchored to second perimeter edge guard section 34b. Second end 38b may be attached to edge guard section 34b with adhesive, fasteners, or any other means of permanently or temporarily attaching two items together. FIG. 11C illustrates the action secured to the edge guard section with adhesive. Alternatively, an action pocket 40 may be integrally formed with the edge guard section 34b, and the action second end 38b may be seated in the action pocket 40. Further, it may be permanently fixed in action pocket 40 or removably attached for easy replacement if the action breaks or loses its resilience of elasticity.

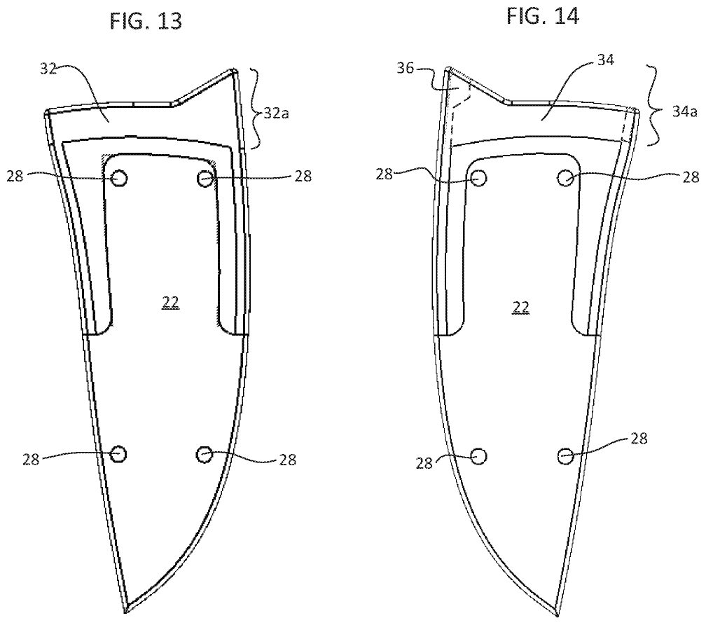

A second embodiment of sheath 20 is shown in FIGS. 13-24, and it also includes one or more sheath supports 22, one or more blade covers 42, 44, and one or more blade guards 32, 34. The second embodiment preferably includes two opposing sheath supports 22 so that the sheath can be attached to gear on a user's left or right side and accordingly used by left- or right-handed persons. The second embodiment of sheath 20 also comprises a sheath protrusion 36 and action 38. When assembled, blade covers and blade guards form a first pocket 90 that accepts the blade 14 of knife 12. Preferably, blade covers and blade guards are shaped such that they substantially compliment or correspond to the shape of blade 14.

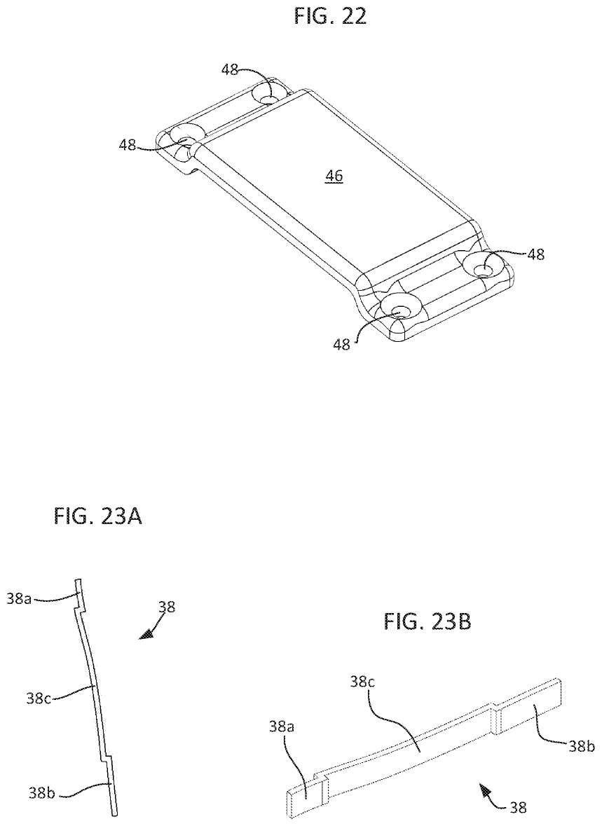

Sheath supports 22, as shown in FIGS. 14-24, preferably are integrally formed with the first and second blade guards respectively. If blade guards 32, 34 are a single component, then supports 22 may also be integrally formed with and on opposing sides of the singled blade guard. Sheath supports 22 as shown in FIG. 14-16 include several openings 28 that facilitate attachment to a belt, vest, or accessories such as the belt attachment 46 shown in FIG. 22. Belt attachment 46 includes cooperating openings 48 for fasteners, and is preferably configured so that a belt can slide through an opening created by sheath support 22 and belt attachment 46.

For the second embodiment shown in FIGS. 14-24, retention system 30 includes first and second blade guards 32, 34 and first and second blade covers 42, 44 that substantially surrounds the edges of blade 14 that do not abut handle 12. The blade guards and the blade covers may be formed from one single piece of material or be comprised of multiple sections for ease of manufacturing. Whether the blade guard is assembled from multiple components or is a single component, first blade guard 32 corresponds to the first side of the blade guard, and second blade guard 34 corresponds to the second side of the blade guard. Similarly, whether the blade cover is assembled from multiple components or is a single component, first blade cover 42 corresponds to the first side of the blade cover, and second blade cover 44 corresponds to the second side of the blade cover. The blade guards and blade covers are preferably made from a strong material or combination of materials such as plastic or leather that is capable of supporting the weight of knife 10. As shown in the FIGS. 14-24, first blade guard 32 includes a handle rest section 32a and a perimeter edge guard section 32b, and second blade guard 34 also includes handle rest section 34a and a perimeter edge guard section 34b.

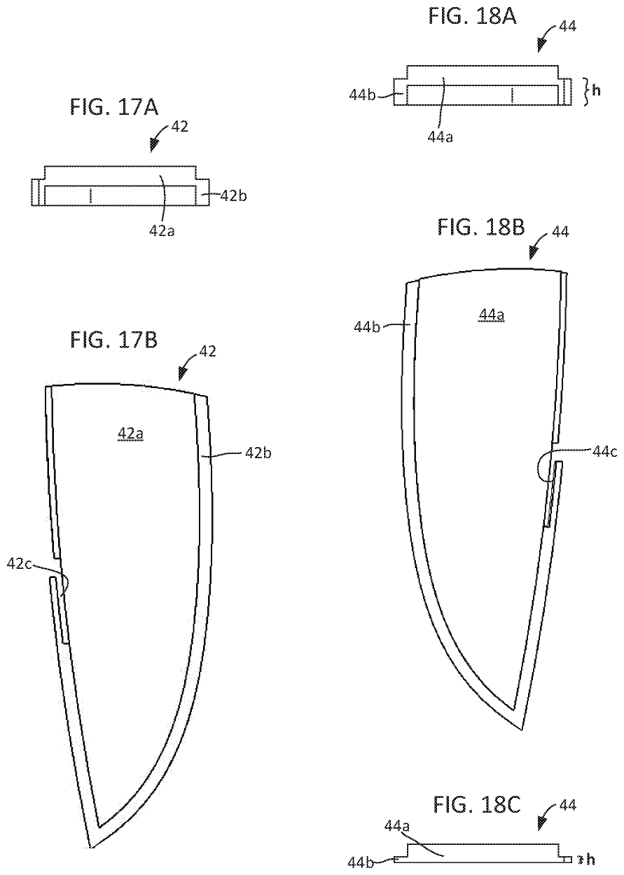

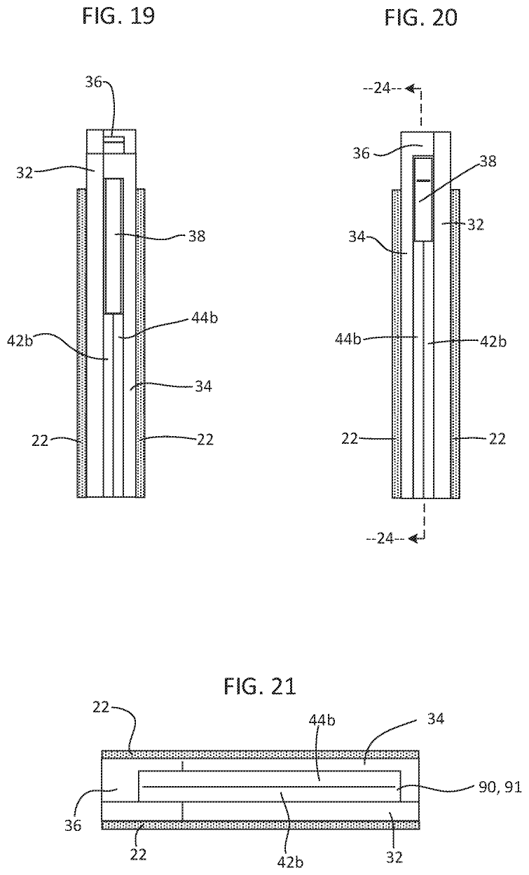

Blade covers 42, 44 are shown in FIGS. 17A-18C and include blade cover perimeter sections 42b, 44b, and first and second blade cover surface sections 42a, 44a. Additionally, blade covers include an attachment spot, slot, cutout, or pocket for action 38, which in FIGS. 17A-18B is shown as first and second action pockets 42c, 44c. As with the first sheath embodiment, the action pockets are positioned so that the action will be near the knife second edge 14b when the knife blade 14 is seated in sheath 20. Blade cover surface sections 42a, 44a are configured to be inserted in first and second blade guards 32, 42 respectively, as shown in FIGS. 19-21. Additionally, preferably blade cover perimeter sections 42b, 44b are configured to sit adjacent first and second perimeter edge guard sections 32b, 34b respectively, as shown in FIGS. 19-21. When first and second blade guards 32 and 34 and first and second blade covers 42 and 44 are combined as shown in FIGS. 19-21, they form a protective barrier around the edge of blade 14. Together the components also define an action opening (not labelled) that is sized to accommodate the action 38 and a second knife pocket 91 that is sized to accommodate blade 14. Blade covers 42, 44 may be attached to blade guards 32, 34 with fasteners, adhesives, or other means; blade covers 42, 44 also may be held in place by the fit and design of blade guards 32, 34. Handle rest sections 34a and 32b are sized and shaped to cooperate with the edge of handle 12 when blade 14 is placed in sheath 20. Perimeter edge guard sections 34b and 32b and blade cover perimeter sections 42b and 44b are sized and shaped preferably to cooperate with and partially conform to the shape of blade 14. Additionally, blade cover perimeter sections 42b and 44b may vary in height h depending on blade needs and manufacturing considerations. For example, FIG. 18A shows blade cover perimeter section 44b having a greater height h than the blade cover perimeter section 44b show in in FIG. 18C.

As with the first embodiment, the second handle rest section 34a of second blade guard 34 also defines protrusion 36 located such that it cooperates with knife protrusion 16 and knife first edge 14a when in use. Sheath protrusion 36 can be integral with second handle rest section 34a or it can be fixedly attached to it. Sheath protrusion 36 can be any shape or any type of protrusion and preferably is sized and formed to compliment and cooperate with knife protrusion 16. FIG. 10 illustrates several shapes and sizes of sheath protrusion 36 and how the sheath protrusion 36 compliments and cooperates with knife protrusion 16. While several combinations of protrusions 36, 16 are shown in FIG. 10, many other cooperating protrusion shapes and sizes can be used as will be understood by someone skilled in the art.

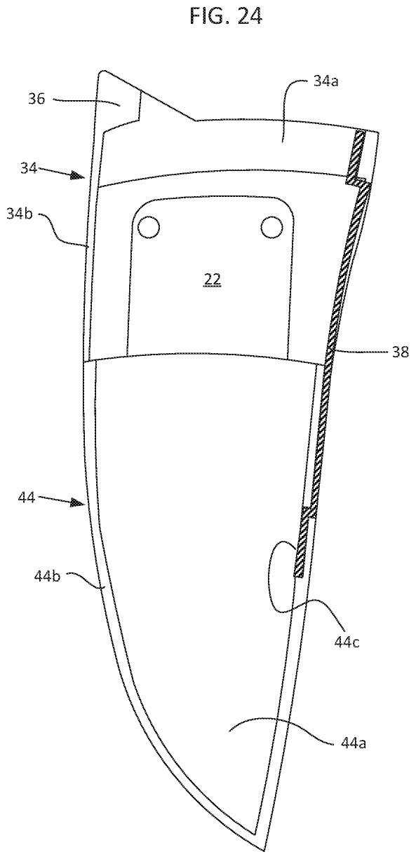

With respect to the second embodiment of the present invention, attached along the first and second blade perimeter sections 42b and 44b and positioned at least partially in first and second blade slots 42c and 44c is action 38. FIGS. 23A and 23B illustrate a preferred embodiment of action 38 for the second embodiment of the sheath where action first end 38a is configured to cooperate with blade guards 32 and 34 as shown in FIG. 24. Additionally, action second end 38b is configured to cooperate with action pockets 42c and 44c as shown in FIG. 24. Action center 38c is positioned so that it can be displaced, depressed, or flexed as the knife and sheath are displaced relative to one another. As with the first sheath embodiment, preferably action center 38c is curved or shaped such that when no force is applied, the knife protrusion 16 of knife blade 14 is biased to lock the knife protrusion 16 and sheath protrusion 36 together, and when pressure is applied to the center section 38c it elastically displaces so that the bias is overcome and the knife protrusion 16 is released from the sheath protrusion 36 and the knife blade 14 can easily be removed or inserted.

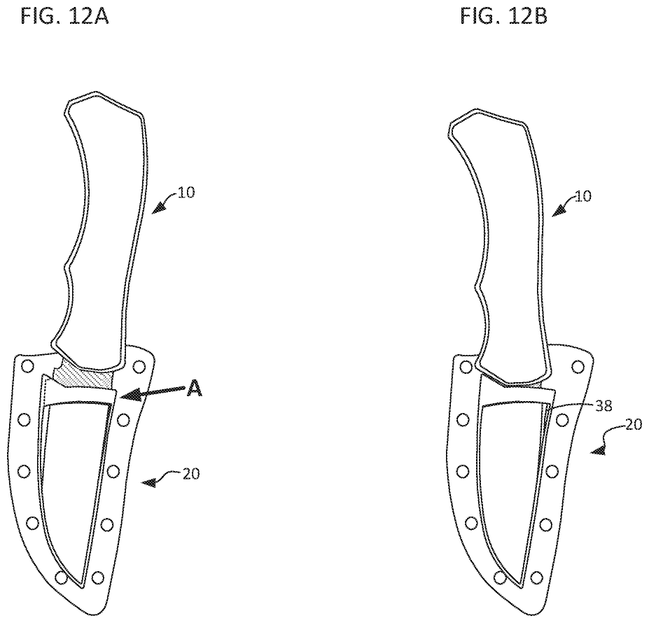

To use sheath 20 and knife 10 together, action 38 must be displaced when inserting and removing knife 10 so that knife protrusion 16 clears the sheath protrusion 36. FIG. 12A illustrates how knife 10 is positioned relative to sheath 20 when it is being inserted and removed. To remove the knife from the sheath, preferably the knife user presses his thumb or finger against point A to move the handle rest sections 32a, 34a of the blade guards and action 38. Once the handle rest sections 32a, 34a of blade guards shift so that sheath protrusion 36 is no longer blocking knife protrusion 16, then the knife can be removed from the sheath. To insert the knife into the sheath, the knife user can press his thumb or finger against point A to move sheath protrusion 36 out of the way. Alternatively and preferably, however, sheath protrusion 36 is configured with at least a partially sloped edge 36a, as shown in FIG. 10, such that the knife user can simply allow the knife blade itself to push sheath protrusion out of the way. After the knife protrusion 16 has cleared the sheath protrusion 36, sheath protrusion 36 shifts to cover knife protrusion 16 due to the bias of action 38, and the knife is seated in sheath 20 as shown in FIG. 12B.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

I claim:

1. A knife and sheath system comprising:
a. a knife comprising a handle, a blade comprising a first edge and a first end, wherein the first end of the blade attaches to the handle, and wherein a knife protrusion extends from the first edge of the knife near the first end; and
b. a sheath comprising:
i. a blade guard defining a knife pocket that receives the knife blade;
ii. a sheath protrusion fixedly attached to the blade guard and extending into the knife pocket, wherein the sheath protrusion is configured to cooperate with the knife protrusion; and
iii. an action having first and second ends and a center section disposed between the first and second ends, wherein the action attaches to the blade guard at one of the action ends and wherein the center section of the action protrudes into the knife pocket.

2. The knife and sheath system of claim 1 wherein the sheath further comprises a sheath support attached to the blade guard.

3. The knife and sheath system of claim 2 wherein the sheath further comprises a spacer attached between the sheath support and blade guard.

4. The knife and sheath system of claim 2 wherein the blade guard comprises a first side and a second side, wherein the first side attaches to a first sheath support and the second side attaches to a second sheath support, and wherein the first and second sheath supports define a plurality of openings configured to cooperate with removably attachable accessories.

5. The knife and sheath system of claim 4 wherein the sheath further comprises a first blade cover attached to the first side of the blade guard and a second blade cover attached to the second side of the blade guard.

6. The knife and sheath system of claim 1 wherein the first end of the action attaches to the blade guard.

7. The knife and sheath system of claim 1 wherein the second end of the action attaches to the blade guard.

8. The knife and sheath system of claim 1 wherein the action comprises a resilient material.

9. The knife and sheath system of claim 1 wherein the action comprises steel.

10. The knife and sheath system of claim 7 wherein the blade guard defines an action pocket and wherein the second end of the action is disposed in the action pocket of the blade guard.

11. A knife and sheath system comprising:
a. a knife comprising a handle, a blade comprising a first edge and a first end, wherein the first end of the blade attaches to the handle, and wherein a knife protrusion extends from the first edge of the knife near the first end; and
b. a sheath comprising:
i. a blade guard comprising a handle section attached to a perimeter section, wherein the handle section and perimeter section define a first knife pocket that receives the knife blade;
ii. a sheath protrusion fixedly attached to the handle section of the blade guard and extending into the knife pocket, wherein the sheath protrusion is configured to cooperate with the knife protrusion;
iii. a blade cover positioned within perimeter section of the blade guard; and
iv. an action having first and second ends and a center section disposed between the first and second ends, wherein the action attaches to the blade cover at one of the action ends and wherein the center section of the action biases the blade cover toward the sheath protrusion.

12. The knife and sheath system of claim 11 wherein the sheath further comprises a sheath support attached to the blade guard.

13. The knife and sheath system of claim 12 wherein the blade guard further comprises opposing first and second sides, wherein the first side attaches to a first sheath support and the second side attaches to a second sheath support, and wherein the first and second sheath supports define a plurality of openings configured to cooperate with removably attachable accessories.

14. The knife and sheath system of claim 13 wherein the first sheath support is integrally formed with the first side of the blade guard and wherein the second sheath support is integrally formed with the second side of the blade guard.

15. The knife and sheath system of claim 11 wherein the first end of the action attaches to the blade cover.

16. The knife and sheath system of claim 11 wherein the second end of the action attaches to the blade cover.

17. The knife and sheath system of claim 11 wherein the action comprises a resilient material.

18. The knife and sheath system of claim 11 wherein the action comprises steel.

19. The knife and sheath system of claim 16 wherein the blade cover defines an action pocket and wherein the second end of the action is disposed in the action pocket of the blade cover.

20. A knife and sheath system comprising:
a. a knife comprising a handle, a blade comprising a first edge, a second edge, and a first end, wherein the first end of the blade attaches to the handle, and wherein a knife protrusion extends from the first edge of the knife near the first end; and
b. a sheath comprising:
i. a blade guard comprising opposing first and second sides and a handle section attached to a perimeter section, wherein the handle section and perimeter section define a first knife pocket that receives the knife blade, wherein the handle section further defines a fixed sheath protrusion that extends into the knife pocket, and wherein the sheath protrusion is configured to cooperate with the knife protrusion and knife first edge;
ii. a blade cover comprising opposing first and second sides and a perimeter edge along a portion of the blade cover perimeter, wherein the blade cover is positioned within perimeter section of the blade guard, wherein the blade cover defines a second knife pocket configured to receive the knife blade, and wherein the blade cover further defines an action pocket along its perimeter edge and adjacent the knife second edge when the knife is seated in the second knife pocket; and
iii. a resilient action having first and second ends and a center section disposed between the first and second ends, wherein the second end of the action is positioned in the action pocket of the blade cover and wherein the center section of the action biases the knife toward the sheath protrusion when the knife is seated in the second knife pocket.
